(19) United States
(12) Patent Application Publication
(10) Pub. No.: US 2005/0070276 A1
(43) Pub. Date: Mar. 31, 2005

(54) Systems and methods that provide modes of access for a phone

(76) Inventor: Rob McGarry, Vancouver (CA)

Correspondence Address: Milan Patel;c/o Nokia Mobile Phones (Patent Dept.), Mail Stop 1-4-755, 6000 Connection Drive, Irving, TX, 75039, US

(21) Appl. No.: 10/672,139

(22) Filed: Sep. 26, 2003

(51) Int. Cl. H04Q 7/20

(52) U.S. Cl. 455/432.2; 455/411; 455/414.1

(57) ABSTRACT

The present invention relates to systems and methods that provide a user the ability to selectively setup a device with limited functionality for another user. The systems and methods can be employed in connection with devices such as a cell phone, a personal computer and the like, wherein the owner can generate and activate various modes of functionality associated with one or more guest users. The foregoing allows the owner to selectively lock out features such as RF transmission in order to mitigate activation of billable services without the owner's consent. The modes of functionality can be configured such that the owner can activate a particular mode at any given time for a particular or any user, or a mode can be activated based on information related to the current user. The foregoing provides for increased device flexibility, efficiency, security and shareability, while mitigating undesired user activity.

### TECHNICAL FIELD

The present invention generally relates to mobile phones, and more particularly to systems and methods that employ various levels of functionality in connection with a mobile phone to provide a user of the mobile phone with selective functionality.

### BACKGROUND OF THE INVENTION

Consumer demand continues to drive the technology industry to develop smaller, lower power, higher bandwidth devices. In response, the technology industry has developed essentially complete systems on a chip, wherein the chip can include analog, digital and/or RF signaling processing circuitry with virtually isolated ground planes. Noise (e.g., parasitic) has been reduced and/or shielded to levels that provide for compact and dense designs without compromising signal integrity. In addition, software applications have been developed to enhance performance, increase flexibility and render user-friendly products. The foregoing and other technological breakthroughs have provided incremental advances and generation leaps towards the ever-growing needs and desires of the consumer and consumer market.

A recent industry trend is to combine or integrate the various technologies within a product. One such industry that exploits technological advances it the automobile industry. Several years ago, automotive manufacturers begin employing computers within vehicles to regulate and control subsystems such as fuel injection, environmental control, fluid level monitoring, available power, etc. Today, computer-related technology is utilized to access emergency road-side service, browse the Internet, facilitate navigation through GPS, initiate and receive phone calls, and watch television, for example. In addition, accessories such as security systems and remote car starting, heat control (e.g., including defroster control) and door/trunk opening, for example, can be installed in a purchased vehicle prior to delivery of the vehicle. Furthermore, audio systems can be obtained that are constructed with removable face plates, security access codes and technology that render the audio systems inoperable without the associated face plate or access code.

Another industry that has integrated technologies is the mobile phone industry. Today's mobile phones include the traditional features such as the ability to initiate or receive a call and enhancements such as call forwarding, call waiting, x-way calling (where x is an integer greater than two) and voicemail. In addition, features such as voice activated dialing, text messaging, Internet browsing, touch screen technology, communication with computers, various chimes and/or vibrations, and real-time information such as the time and weather, have been incorporated into mobile phone design. Recent additions include executable applications such as games (e.g., including on-line) and electronic books (e.g., novels and phonebooks), input/output ports for interfacing with a computer for uploading and downloading information, photography capabilities, radio reception, and video capabilities.

One obstacle in the mobile phone industry is the ability to enable the owner of the mobile phone to allow another the privilege of utilizing the mobile phone, while limiting the access available to the other user. Fore example, the owner of the mobile phone may desire to allow his child to utilize the mobile phone to play locally stored games or access locally stored applications. However, conventional mobile phones do not provide a mechanism that prevents the child from utilizing the other features provided within the phone. Thus, the child can inadvertently access a billable service (e.g., initiate a call), change customized settings and/or delete stored phone numbers, for example, without the owner's consent.

Traditional techniques employed to mitigate undesired access to the mobile phone (e.g., access to some of the features available) by a guest user include supervising the guest user while the guest utilizes the mobile phone or abstaining from allowing the guest user from utilizing the mobile phone. Thus, conventional techniques can be inflexible, can deter efficient mobile phone utilization, and can dissuade the owner from providing access to others, even when the owner desires the allow another with access to the mobile phone.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to systems and methods that provide one or more access modes, wherein an activated access mode defines an available level of user functionality. By way of example, a cell phone can be utilized to initiate calls, receive calls, play games, view animations, etc. The owner of the cell phone may desire to let others utilize the phone to employ one or more of these features. For example, the cell phone owner may have children of various ages ranging from an infant to a teenager who can utilize the phone. The owner may desire to provide the teenager with greater access to the cell phone's features than the infant. The present invention provides the owner the ability to define a plurality of access modes (e.g., an teenager mode and an infant mode) with varying levels of available functionality, wherein a suitable access mode can be activated based on the user.

With conventional systems, the owner typically prohibits others from employing the phone in order to ensure that features will not be utilized contrary to the owner's desires. Thus, an owner who desires to allow another to employ some of the phone features (e.g., a local game) may refrain from relinquishing the phone to the other to mitigate possible utilization of other features (e.g., a billable service). The present invention mitigates such conflicts via providing the owner with access modes that define the features that can be accessed when an access mode is activated. Thus, the present invention provides for increased flexibility, efficiency and shareability, while mitigating undesired activity.

In one aspect of the present invention, a system is provided that distributes modes of operation, wherein respective modes define a level of functionality. The system can interface with various other systems through an interface, wherein the other systems can provide requests and/or information to the distribution component via the interface. The distribution component can utilize at least a portion of the request and information to retrieve a suitable mode of operation. The mode of operation can be loaded and employed or conveyed and loaded at a later time.

In another aspect of the present invention, a system is illustrated wherein a bank of modes (e.g., predefined and user generated) is utilized to service user requests. Upon receiving a input, the system determines a desired mode, obtains the mode and either activates the mode or convey the mode for subsequent activation. In yet another aspect of the present invention, a system is provided that employs user information to locate a mode for the user. The user information can include a user log on, a password, an iris map, a fingerprint, voice and/or other known characteristics that are substantially unique from user to user. The information can be employed to identify the user, wherein the user's identification can be mapped to the level of functionality or the information itself can be mapped to a level of functionality. Once the level of functionality is determined, the system can load and/or convey the privileges for the user.

Methodologies are provided wherein information such as a desired mode and/or user information is received and subsequently utilized to obtain and activate and/or convey the mode. In instances where a signal (e.g., a button press) is received, the signal can be interpreted to determine the mode, and in instances where user information is received, the user information can be mapped to the mode. Additionally, intelligence can be employed to automatically select the mode based at least in part on the received signal and/or user information and automatically add/remove privileges based at least in part on the user activity.

To the accomplishment of the foregoing and related ends, certain illustrative aspects of the invention are described herein in connection with the following description and the annexed drawings. These aspects are indicative, however, of but a few of the various ways in which the principles of the invention may be employed, and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 illustrates an exemplary mode distribution system, in accordance with an aspect of the present invention.

FIG. 2 illustrates an exemplary mode loading system, in accordance with an aspect of the present invention.

FIG. 3 illustrates an exemplary mode retrieval system, in accordance with an aspect of the present invention.

FIG. 4 illustrates an environment wherein the invention can be employed.

FIG. 5 illustrates an exemplary methodology that actives a mode, in accordance with an aspect of the present invention.

FIG. 6 illustrates an exemplary methodology that selects a mode based on user information, in accordance with an aspect of the present invention.

FIG. 7 illustrates a first exemplary technique to define levels of functionality, in accordance with an aspect of the present invention.

FIG. 8 illustrates a second exemplary technique to define levels of functionality, in accordance with an aspect of the present invention.

FIG. 9 illustrates a third exemplary technique to define levels of functionality, in accordance with an aspect of the present invention.

FIG. 10 illustrates exemplary modes of operation, in accordance with an aspect of the present invention.

FIG. 11 illustrates a first exemplary pseudo code that defines levels of functionality, in accordance with an aspect of the present invention.

FIG. 12 illustrates a second exemplary pseudo code that defines levels of functionality, in accordance with an aspect of the present invention.

FIG. 13 illustrates an exemplary system that employs intelligence to facilitate providing functionality, in accordance with an aspect of the present invention.

FIG. 14 illustrates an exemplary mobile device wherein the invention can be employed.

FIG. 15 illustrates an exemplary network wherein the invention can be employed.

FIG. 16 illustrates an exemplary computing environment wherein the invention can be employed.

### DETAILED DESCRIPTION OF THE INVENTION

The present invention relates to systems and methods that provide various level of functionality that can be activated within a device (e.g., a cell phone), wherein the activated level defines a scope of functionality available to a user of the device. The systems and methods include a mechanism that selectively provides access to the device based on the user. Conventionally, a device owner prevents others from utilizing the device in a manner adverse to the owner's desires via not allowing others access to the device, even when the owner desires to allow limited utilization. The access modes of the present invention mitigate such conventional techniques and increase device flexibility, efficiency and shareability.

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

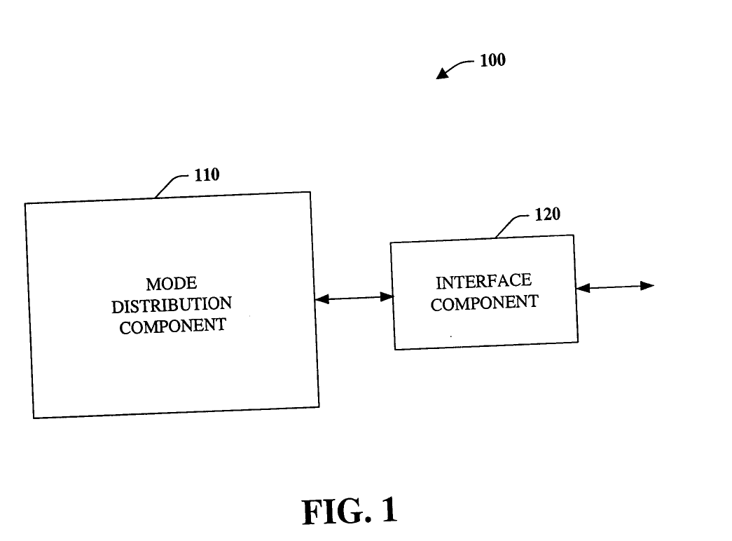

FIG. 1 illustrates an exemplary system 100 that defines user functionality, in accordance with an aspect of the present invention. The system 100 comprises a mode distribution component 110 that can provide a level of functionality and an interface component 120 that can couple the mode distribution component 110 with various systems (e.g., a computer, a phone (e.g., mobile and cordless) and a network) to facilitate conveyance of the level of functionality to one or more of the various systems.

A level of functionality (“level”), as utilized herein, generally relates to a set or subset of available functionality. For example, a user of a cell phone can be provided with the ability to initiate or receive a call and employ features such as call forwarding, call waiting, x-way calling (where x is an integer greater than two), voicemail, voice activated dialing, text messaging, Internet browsing, etc. In addition, contemporary phones typically provide the user with executable applications such as games and phonebooks, user preferences such as various chimes and/or vibrations, real-time information such as the time and weather, and non-phone related aspects such as photography, radio and video capabilities. Moreover, to utilize and/or modify the foregoing, the user can be provided with an alphanumeric keypad, a function key(s), a menu key(s), a volume control, a microphone, a speaker, an I/O port, a memory card interface/port, a power control, and a display. A level of functionality for the present example can include some (e.g., a subset) or all (e.g., the set) of the above-noted features.

By way of example, one level (e.g., administrative) can provide a user with full access, while another level can be configured to provide the user with access to all the features except the ability to invoke a game. Another level can be configured to lock the preferences so the user cannot modify current preferences. Yet another level can be configured to disable RF transmission. Still another level (e.g., a security level) can be configured to disable substantially all the features. It is to be appreciated that the foregoing exemplary levels are provided to illustrate suitable examples and are not an exhaustive list. Any known feature and/or combination thereof could be employed in accordance with an aspect of the invention. In addition, it is noted that the invention is not limited to a cell phone. Virtually any component (e.g., a device, a system and the like), especially where it is desirable to delineate levels of functionality, can employ the system 100.

The levels provided by the mode distribution component 110 can be variously obtained, as described in detail below. Briefly, in one aspect of the present invention a level can be generated and uploaded (e.g., via the interface component 120) to the system 100 or a storage area accessible to the system 100. In another aspect of the present invention, a mode creating utility (e.g., an API and GUI-based tool) can be employed to create, modify and delete a level. In yet another aspect of the present invention, intelligence (e.g., inferences, probabilities and statistics) can be employed to automatically or semi-automatically define a level. In still another aspect of the present invention, the component utilizing the system 100 can generate, edit and destroy a level. Moreover, any combination of the above-noted aspects can be provided and utilized.

The interface component 120 can be utilized to couple the mode distribution component 110 with a system (not shown) and facilitate communication between the mode distribution component 110 and the system. As previously noted, the communication can include conveyance of a level from the mode distribution component 110 to the system. For example, the system can request and/or retrieve a level from the mode distribution component 110. In another example, the mode distribution component 110 can transmit the level to the system. In one instance, the mode distribution component 110 can transmit the level after receiving a request based on user information (e.g., a logon, a password, voice, an iris map, a fingerprint and/or a facial characteristic), wherein the user information and/or user is associated with a level. In another instance, the request includes information indicative of the desired level and/or information that can be utilized by intelligence to provide a “best” level base on the information.

It is to be appreciated that the interface component 120 can provide for various types of communication such as optical, electrical, RF, IR and the like. In addition, the interface component 120 can provide for serial and/or parallel communication, including multiplexed, encrypted, encoded and/or modulated information. Furthermore, the interface component 120 can comprise one or more uni- and/or bi-directional channels. Moreover, suitable hardware and/or software can be employed in connect with the interface component 120 to convert, condition and/or process the information.

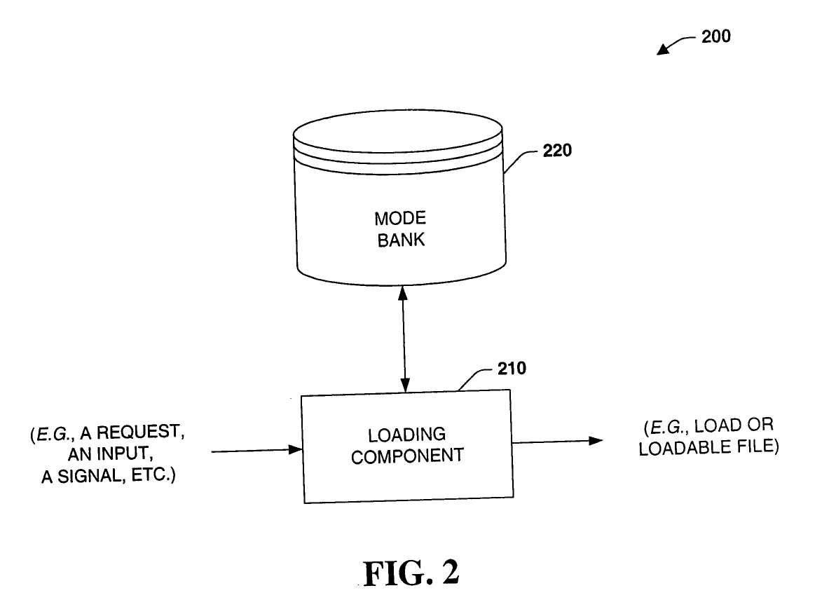

FIG. 2 illustrates an exemplary system 200 that can initiate and/or upload an accessibility mode to a device, wherein the mode defines an amount of user accessibility with the device, in accordance with an aspect of the present invention. The system 200 comprises a loading component 210 (e.g., the system 100) that launches or transmits the mode and a mode bank 220, wherein one or more modes can be stored.

In general, the loading component 210 can receive information (e.g., a request, an input, a signal, etc.) indicative of a desire to activate a mode. For example, a user can depress a key (e.g., physical and virtual (e.g., touch screen)), enter a sequence of keystrokes and/or provide audio input (e.g., voice) that invokes the transmission of information that indicates the mode the user intends to activate to the loading component 210. The loading component 210 can utilize the information to retrieve a suitable mode from the mode bank 220.

The mode bank 220 can be any known storage medium. For example, in one aspect of the present invention, the mode bank 220 can be memory (e.g., RAM, CMOS, hard disk) that resides local to the loading component 210. In another aspect of the present invention, the mode bank 220 can be a central, common and/or shared database, which is accessed through a network (e.g., physical and wireless). In yet another aspect of the present invention, the mode bank 220 can be located on a CD, DVD, optical disk, tape, floppy, zip cassette, jaz cassette, memory card, and the like.

After receiving the information, the loading component 210 can obtain the mode from the mode bank 220 via retrieving and/or requesting the mode. Once the mode is obtained by the loading component 210, the loading component can execute the mode and/or convey the mode. In systems that provide for mode execution, the loading component 210 can launch the mode via running an executable program, compiling and running a program or sequentially interpreting a set of instructions, for example. With systems that provide for mode conveyance, the loading component 210 can transmit the mode where the mode can be further operated on (e.g., executed, modified, converted, etc.). In systems that provide for both mode execution and conveyance, the user can provide additional information that facilitates determining whether the mode is launched or conveyed.

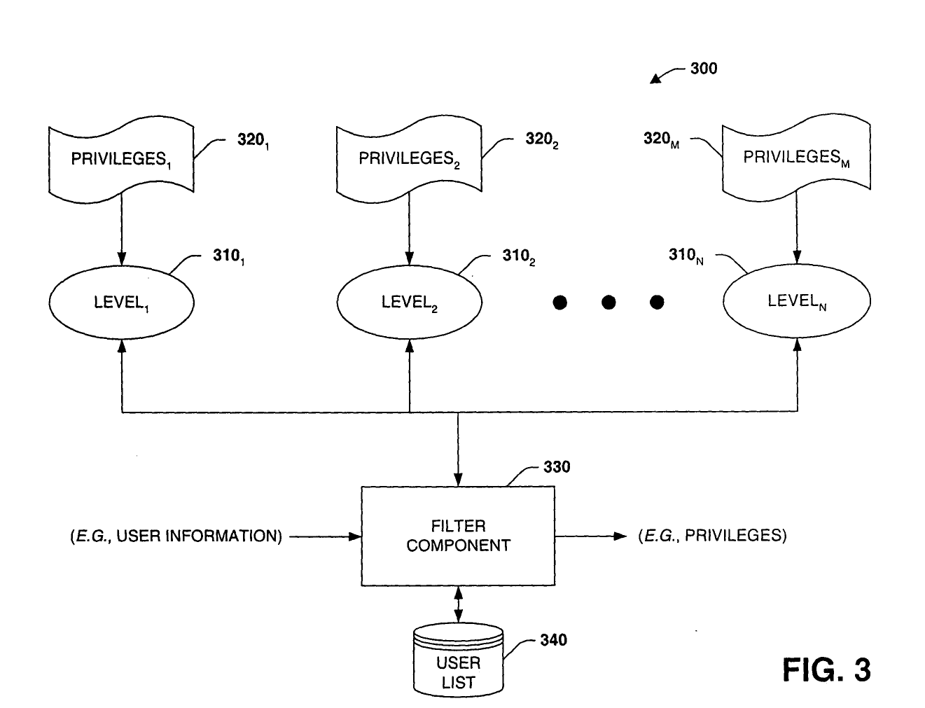

FIG. 3 illustrates an exemplary system 300 that provides a set of privileges for a user, based on received information associated with the user, in accordance with an aspect of the present invention. The system 300 comprises a level 310₁, a level 310₂, a level 310_{N}, (where N is an integer greater or equal to one), a privileges 320₁, a privileges 320₂, a privileges 320_{M} (where M is an integer greater or equal to one), a filter component 330, and a user list 340. Hereafter, the level 310₁, 310₂ and 310_{N} can be collectively referred to as levels 310 and the privileges 320₁, 320₂ and 320_{M} can be collectively referred to as privileges 320.

Levels 310 can be utilized to access groups of user privileges (e.g., one or more of the privileges 320). Typically, respective levels 310₁, 310₂ and 310_{N} include access to at least one privilege such that the respective levels represent different sets of privileges. However, it is to be appreciated that two or more levels can be very similar. For example, a first and second level can be defined and personalized, wherein the levels can include substantially similar or the same content, but are associated with different (e.g., unique) identifications. Thus, either level can be utilized to provide the access. In can further be appreciated that where a generic (e.g., “level 1”) identification or a similar level is defined that the system 200 can recognize the similarity and mitigate creating duplicate levels. In one aspect of the present invention, at least one of level 310₁, 310₂ and 310_{N} can be an administrative level that can be employed to create, modify and destroy other levels.

Privileges 320 can be utilized to store the access available through the levels 310. As depicted, M=N such that respective levels 310 are associated with at least one corresponding privilege. However, it is noted that a level can be associated with more than one privilege, including shared privileges. For example, a level can be associated with an aggregate of existing privileges and/or portion of a privilege. In another example, a level can be disassociated with a privilege, wherein the level can be utilized to provide a user access to all available features (e.g., an administrative level) or to no feature (e.g., a security level that locks-out substantially all features). Thus, the invention contemplates scenarios where M can be equal to, greater or less than N.

Privileges 320 can be obtained by the filter component 330 through levels 310. For example, the filter component 330 can receive an input (e.g., user information) that is indicative of a level and/or privilege associated with the user. For example, a user can log on to device, wherein the log on information can be utilized to identify the user via the user list 340. Once the user is identified, the user can be mapped to one of the level 310 and/or one of the privileges 320, and the filter component 330 can obtain the respective privileges and forward them to another component or load them for utilization.

The user list 340 can include the users granted privileges, including a generic (e.g., guest) user that can be utilized to provide temporary and limited access. The generic user can be configured, for example, to expire after a time duration, a number of user requests (e.g., keystrokes) and/or upon completion of a demonstration or training application. Respective users in the list can be identified through user information such as a logon, a password, voice recognition, an iris map, a fingerprint and/or a facial characteristic. In addition, user information can be provided manually via text and/or voice, the reading of an identification card and/or a pattern associated with a unique key. It is to be appreciated that levels 310, privileges 320 and users can be generated, modified and/or removed from the system 300. For example, a use with access to an administrative level can be provided with such rights. In addition, levels 310, privileges 320 and users can be generated, modified and/or removed via an API, a utility, a tool, a GUI-based application, and/or uploading.

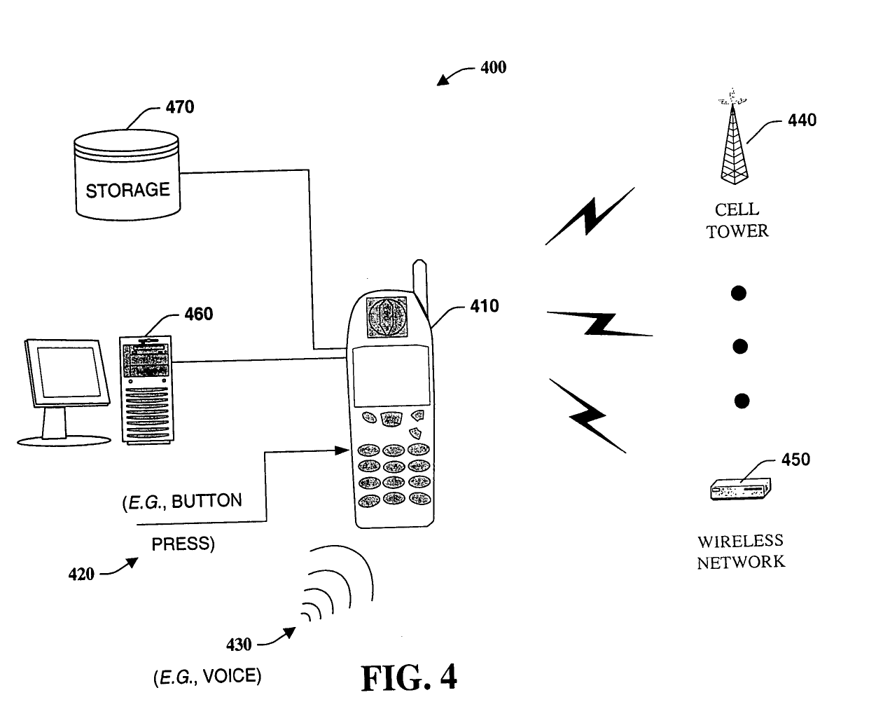

FIG. 4 illustrates an exemplary environment in which the novel aspects of the invention can be employed. A component 410 is depicted as a cell phone for sake of brevity; however, it is to be appreciated that the component 410 can be virtually any device that can provide various degrees of capabilities based on a user and/or a selected set of capabilities, for example. A user can interact with the component 410 via a physical stimulus 420, an audio stimulus 430, a cell tower 440, a wireless network 450, and a microprocessor-based device 460.

The physical stimulus 420 can be, for example, a user employing the buttons on the device 410. For example, the user can activate a mode of operation that provides a level of functionality via depressing a button(s) associated with the component 410 that selects the mode of operation. In one aspect of the present invention, the user provides information prior to selecting the mode. For example, the user can provide a unique identification, which allows the user to select at least one mode of operation. In one instance, the selected mode of operation remains employed until the activating user deactivates the mode of operation (e.g., after re-submitting the unique identification) or an event (e.g., time lapse, time of day, day of week and a power shutdown/cycle) occurs. In another aspect of the present invention, the user obtains a code (e.g., a name and/or number) after selecting the mode of operation, wherein the code can be subsequently utilized to change the mode of operation. The foregoing provides a technique(s) wherein a user (e.g., an owner or device administrator) can select a mode of operation for a preferred level of functionality or a mode of operation that limits the actions of another user (e.g., the owner's child).

The audio stimulus 430 can comprise a user's voice, a tone, an audio command and the like, any of which can be utilized to effectuate the device 410 as described above in connection with the physical stimulus 420. The system 400 can include a mechanism (not shown) to learn one or more audio stimuli. For example, the user can read various training sets into device, wherein the device learns to discriminate patterns, pitches, tones, verbiage and/or other known voice characteristics. The system 400 can save and/or update the information. For example, the user can save various sets of data so that the user's voice can be recognized under circumstances where the user's voice changes over time. For example, a singer's voice can be different depending on whether the singer has performed a concert. Additionally, the user can update the saved data by repeating training sets. For example, an adolescent's voice can change as the adolescent matures into an adult. During the change, the device 410 can begin to have difficulty recognizing the voice such that the adolescent is required to vociferate several times. The adolescent can update the saved information such that device can learn the changes and even anticipate future voice changes.

The cell tower 440, wireless network 450 and the microprocessor-based system 460 can be associated with any system that can transmit a message suitable for reception by the device 410. For example, a device similar to device 410 can transmit a remote message via the cell tower 440 and/or wireless network 450 (e.g., Bluetooth, Wi-Fi, etc.). The microprocessor-based system 450 can be a PC, mainframe, workstation, hand-held, notepad, palm top, personal data assistant, laptop, organizer, and the like. The cell tower 440, wireless network 450 and the microprocessor-based system 460 can be employed in connection with the device 410 to induce behavior similar to that initiated via the physical stimulus 420 and the audio stimulus 430.

When the user employs the physical stimulus 420, the audio stimulus 430, the cell tower 440, the wireless network 450 and/or the microprocessor-based device 460 to provide an input to the device 410, the input can be utilized to determine an action for the device 410. In one aspect of the invention, the input can signify a mode that the user desires to engage. For example, the user can activate a mode that prevents a user, including the user, from placing calls via the device 410 when the amount of purchased service hours is nearly depleted. Such a feature enables the user to block another from initiating a call from the device 410 and remind himself that the allotted time is low. In another aspect of the present invention, the input can be indicative of the user such that a mode can be pre-selected based on the user employing the device 410. The device 410 can obtain the mode from the cell tower 440, wireless network 450, microprocessor-based system 40 and/or the storage 470.

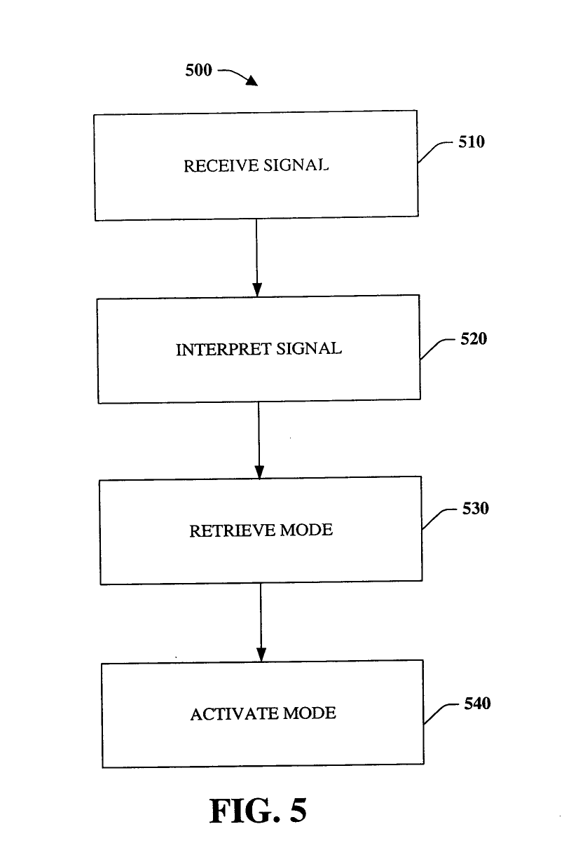

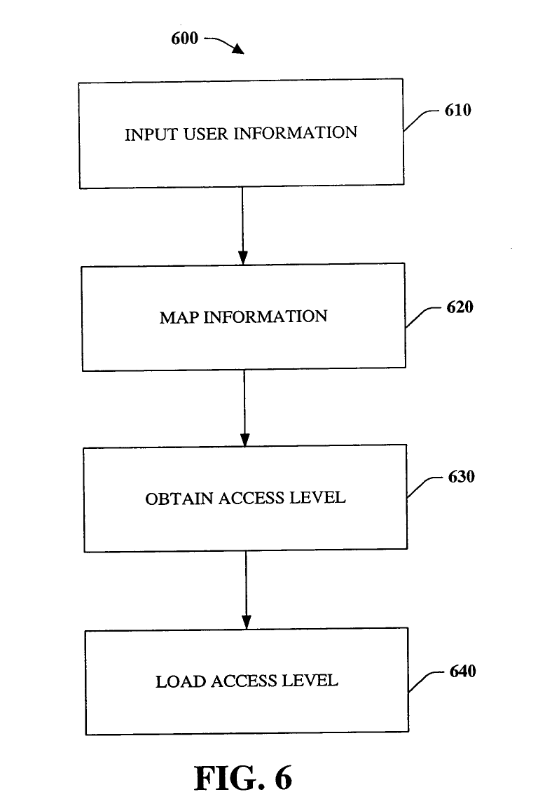

FIGS. 5 and 6 illustrate methodologies, in accordance with an aspect the present invention. While, for purposes of simplicity of explanation, the methodologies are shown and described as a series of acts, it is to be understood and appreciated that the present invention is not limited by the order of acts, as some acts can, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Proceeding to FIG. 5, an exemplary method that activates a mode is illustrated, in accordance with an aspect of the present invention. At reference numeral 510, a signal indicative of the mode to activate is received. The signal can originate from the various sources, as described above. In addition to the above-noted sources, the signal can be a result of slider movement, an electrical connection, activation of a region on a screen, perturbing a magnetic filed, speaking an utterance and/or receiving a message/signal from another device.

At reference numeral 520, the signal can be interpreted. For example, the signal can indicate that a particular mode (e.g., one of a plurality of modes) should be invoked. In addition, the signal can include other information that can facilitate selecting the mode form the plurality of modes. Moreover, the signal can be encrypted, encoded, modulated, enclosed in an enveloped, and/or compressed wherein a suitable mechanism can be employed to decrypt, decode, demodulate, extract, and/or decompress the signal. In addition, the signal can be provided as instructions such as a markup language-based file, compiled code, or an executable.

At 530, the mode indicated in the signal can be retrieved, and at 540 the mode can be activated. It is to be appreciated that the mode can be retrieved from various storage mediums such as local memory, a centralized database, portable memory, and the like. In addition, the mode can be retrieved via transmitting a request to a database and/or another device. Activation of the mode typically occurs in connection with retrieval. However, the mode can be retrieved and activated at a later time. For example, the signal can provide instructions to download more than one mode from a remote device. Thereafter, the other information within the signal or another signal can be provided to select one of the downloaded modes to activate.

Referring next to FIG. 6, an exemplary method that automatically loads a mode based on user information is illustrated, in accordance with an aspect of the present invention. Proceeding to reference numeral 610, user information is obtained. The user information can include indicia indicative of the user. At 620, the indicia can be mapped to determine a user identification, which can be utilized to determine a level of access to provide to the user. Typically, more than one level of access exists, wherein respective users can be associated with one or more levels of access.

At reference numeral 630, the level of access for the user is obtained. When more than one level of access exists for the user, the user information can be employed to facilitated determining which level of access to employ. For example, a user's recent history can be employed to predict which level of access the user desires to employ or intelligence can be utilized to infer the level of access. In addition, the user information can include a preference, priority or other indicator that facilitates selecting the level of access. At 640, the level of access is loaded. The user can then employ the functionality provided through the respective level.

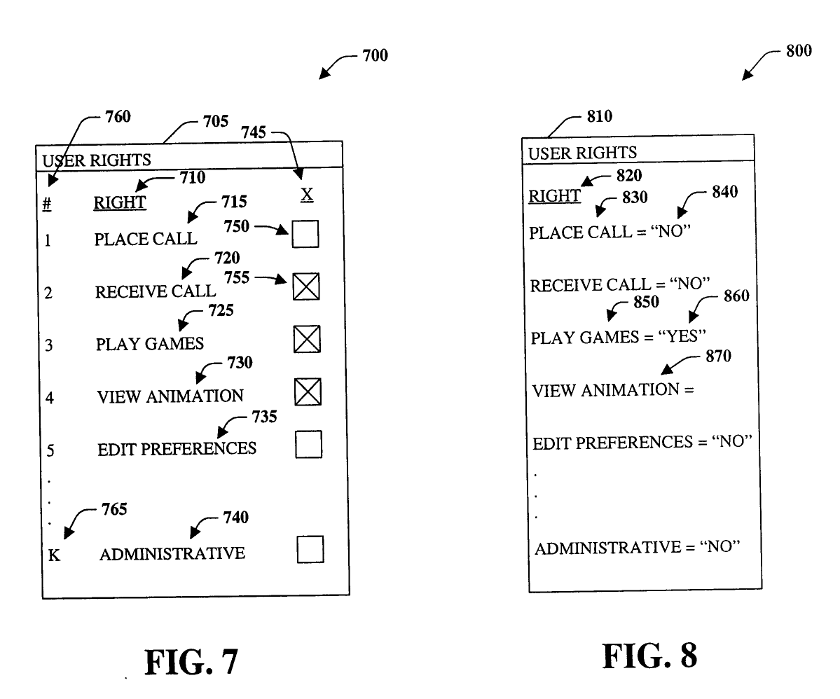

FIGS. 7-9 illustrate exemplary techniques that can be employed in connection with the novel aspects of the present invention to provide a user with accessibility via a common and/or user-associated mode. It is to be appreciated that the structure, entries and fields illustrated in the subject figures do not limit the present invention, but are provide for explanatory purposes and sake of brevity. In addition, the techniques are depicted through lists; however, it is to be appreciated that the technique can comprise any known method such as file(s), table(s), executable(s), etc.

Proceeding to FIG. 7, an exemplary technique 700 is illustrated, in accordance with an aspect of the present invention. The technique 700 comprises a list 705 of available user rights, wherein the list 705 can be associated with a particular user, one or more users or all users.

The list 705 includes a column 710, wherein the privileges available to the user, users or group can be defined. For example, the technique 700 depicts a PLACE CALL entry 715 that can be activated or deactivated. Activating the entry 715 provides the user with the ability to initiate calls, whereas deactivating the entry 715 prohibits the user from initiating a call. The RECIEVE CALL entry 720 can be utilized to determine whether the user can accept a call. It is to be appreciated that when the user is prevented from accepting the call that the call can roll over to a voice mail, forwarding and/or paging system, wherein information such as call identification, time of call and number, for example, and a message can be stored. The PLAY GAMES entry 725 and VIEW ANIMATIONS entry 730 can be activated to allow the user to launch and interact with games and observe applications, respectively.

The EDIT PREFERENCES entry 735 provides the user with access to utilities such as settings, profiles and personal customization for the mode and/or user. Examples of such preferences can include tone selection, text size and color and display items and arrangement. The ADMINISTRATIVE entry 740 can be a top-most mode, which typically includes full access. The entry 740 can provide administrative rights, which can provide the user with the ability to create, modify and destroy modes and/or users.

Rights can be granted via providing an indicator next to the entry within the list 705. As illustrated, the list 705 includes an activation/deactivation column 745. Activation can comprise either adding or removing an “X” from a corresponding entry. By way of example, the entry 750 indicates that either the “X” has not been added or has been removed, whereas the entry 755 indicates that either the “X” has been added or has not been removed. In addition, a default configuration can be initially provided that activates/deactivates all or a portion of the entries. The list 705 further includes a column 760, which provides of technique to enumerate rights. The column 760 is illustrated to include a K entry 765, where K is equal to or greater than one. However, it is to be appreciated that various lists can include the same or different types and/or numbers of entries. Additionally, K can vary as rights are added or removed from column 710.

Turning to FIG. 8, an exemplary technique 800 is illustrated, in accordance with an aspect of the present invention. The technique 800 is similar to technique 700, wherein it comprises a list 810 with a column 820 of available user rights and the list 810 can be associated with a particular user, one or more users or all users.

User rights can be activated in the list 810 via a text indicator that succeeds the right. For example, the right PLACE CALL 830 is followed by a “NO” text indicator 840, which generally indicates that the right has not been activated. In another example, the right PLAY GAMES 850 is followed by the “YES” text indicator 860, which generally indicates that the right has been activated. In yet another example, the right VIEW ANIMATION 870 has not been associated with a text indicator. In various aspects of the invention, a right without an indicator can default to either an activated or deactivated state, depending on the default setup.

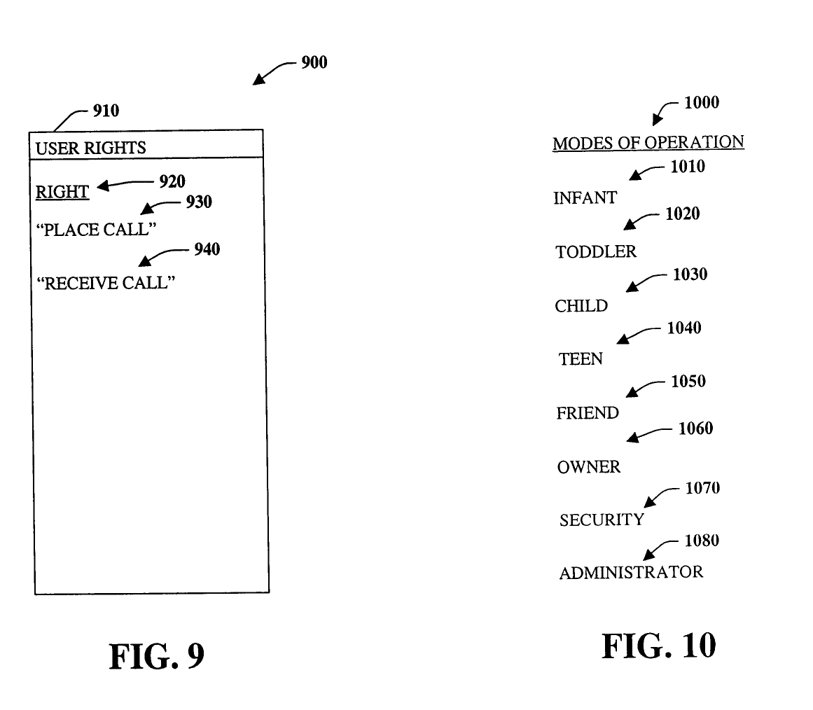

Next at FIG. 9, an exemplary technique 900 is illustrated, in accordance with an aspect of the present invention. The technique 900 comprises a list 910 wherein a right can be activated simply by entering the right under the column 920. For example, the list 910, as depicted, provides a user(s) with the ability to place and receive calls via a PLACE CALL entry 930 and a RECEIVCE CALL entry 940.

FIG. 10 illustrates exemplary modes of operation 1000, in accordance with an aspect of the present invention. The exemplary modes of operation 1000 include an infant 1010, a toddler mode 1020, a child mode 1030, a teen mode 1040, a friend mode 1050, an owner mode 1060, a security mode 1070, and an administrator mode 1080.

Suitable privileges for a sample of the foregoing modes of operation include the following. The infant mode 1010 can be configured to disable RF transmission and all keys except the power key and/or a key sequence. Infant mode can be activated and an animation can be launched such that the infant can view the animation. Since transmission is disabled and the keys are locked, the infant cannot accidentally initiate a call, access a billable service and/or change the configuration. The toddler mode 1020 can be created to deactivate RF transmission, selectively lockout utilities other than games and applications, and enable a limited number of keys that allow the toddler to play games and interact with the applications. Similar to infant mode 1010, toddler mode 1020 mitigates accidental initiation of a call, access of a billable service and/or a change in the configuration. The child mode 1030 can be defined similar to toddler mode 1020 except that it enables RF transmission for on-line gaming.

It is to be appreciated that the foregoing modes 1010-1080 and privileges are provided for explanatory purposes and do not limit the invention. Various aspects of the invention can include more or less and/or similar or different modes and privileges, in accordance with an aspect of invention. In addition, respective modes 1010-1060 can be associated with techniques 700, 800 and/or 900 or other technique, wherein one or more of the modes 1010-1060 can employ one of the techniques 700, 800 and 900 to provide a user with a set or subset of access. In addition, the modes 1010-1060 can be associated with a file that defines user access.

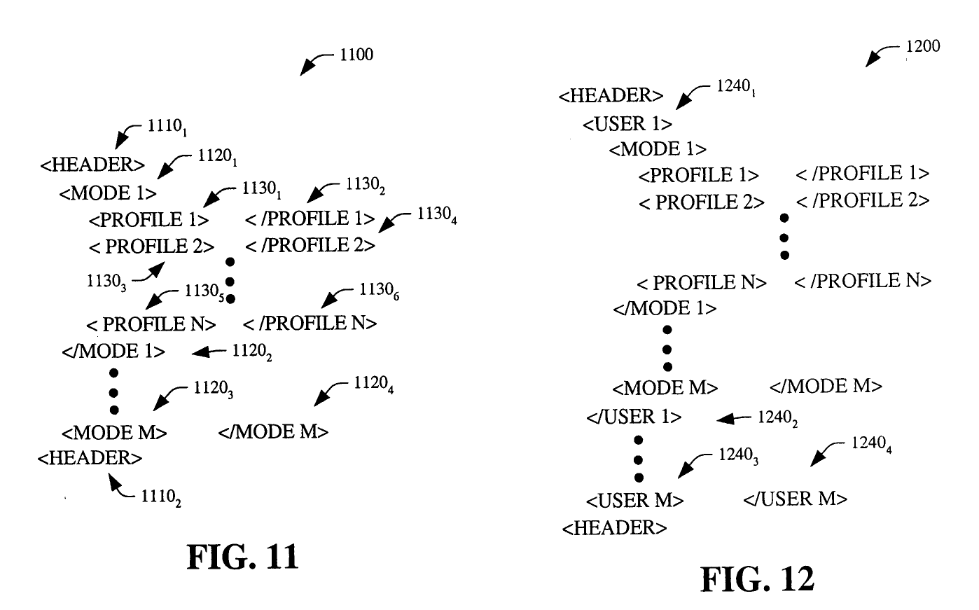

FIGS. 11-12 illustrate exemplary pseudo code that can be employed in accordance with an aspect of the present invention. The following descriptions are directed towards markup language based formats; however, it can be appreciated that various other formats can be employed in accordance with an aspect of the present invention. Furthermore, it is to be appreciated that the structure, entries and fields illustrated are not limitative, but are provide for understanding and explanatory purposes.

FIG. 11 illustrates exemplary XML-based pseudo code 1100 that can be employed in accordance with an aspect of the present invention. The pseudo code 1100 comprises a header field 1110₁, a header field 1110₂, a mode field 1120₁, a mode field 1120₂, a mode field 1120₃, a mode field 1120₄, a profile field 1130₁, a profile field 1130₂, a profile field 1130₃, a profile field 1130₄, a profile field 1130₅, and a profile field 1130₆. The header fields 1110₁ and 1110₂ can be hereafter collectively be referred to as header fields 1110, the mode fields 1120₁-1120₄ can be hereafter collectively referred to as mode fields 1120, and the profile fields 1130₁-1120₆ can be hereafter collectively referred to as profile fields 1120.

As noted supra, information associated with a mode can be included within a file (e.g., embedded and encapsulated). The exemplary pseudo code 1100 described herein illustrates one such file. In particular, the header field 1110₁ can be utilized to designate the beginning of the information related to modes 1120, and the header field 1110₂ can be utilized to designate the ending of the information related to modes 1120.

The mode fields 1120 can be included within the header fields 1110 to designate the available modes. For example, the mode fields can be employed to designate a first mode (“MODE 1”) and an Mth mode (“MODE M”), wherein M is an integer greater than or equal to one. The profile fields 1130 can be included within the mode fields 1120 to associate a profile(s) with a mode. For example, the profile fields 1130 can comprise a list of available functionality wherein respective items are denoted with indicia that defines whether the functionality can be employed via the mode. In another example, the items in the list can reflect the functionality that is provided.

The exemplary pseudo code 1100 can be employed as a basic architecture for employment with the systems and methods described herein. Thus, the systems and methods can obtain and employ a file based on the pseudo code 1100 in order to provide a desired level of functionality. In addition, the system and methods described herein can construct a file based on the pseudo code 1100 that includes the modes and respective privileges.

FIG. 12 illustrates exemplary XML-based pseudo code 1200 that can be employed in accordance with an aspect of the present invention. The pseudo code 1200 comprises the header fields 1110, the mode fields 1120, the profile fields 1130, and a user field 1240₁, a user field 1240₂, a user field 1240₃, and a user field 1250₄. The user fields 1240₁-1240₄ can be collectively referred to as user fields 1240. The user fields 1240 can be utilized within the code 1200 to provide another level of delineation via associating users with respective modes. Thus, a mode can be activated by selecting the mode or a user, wherein the mode associated with the user is loaded.

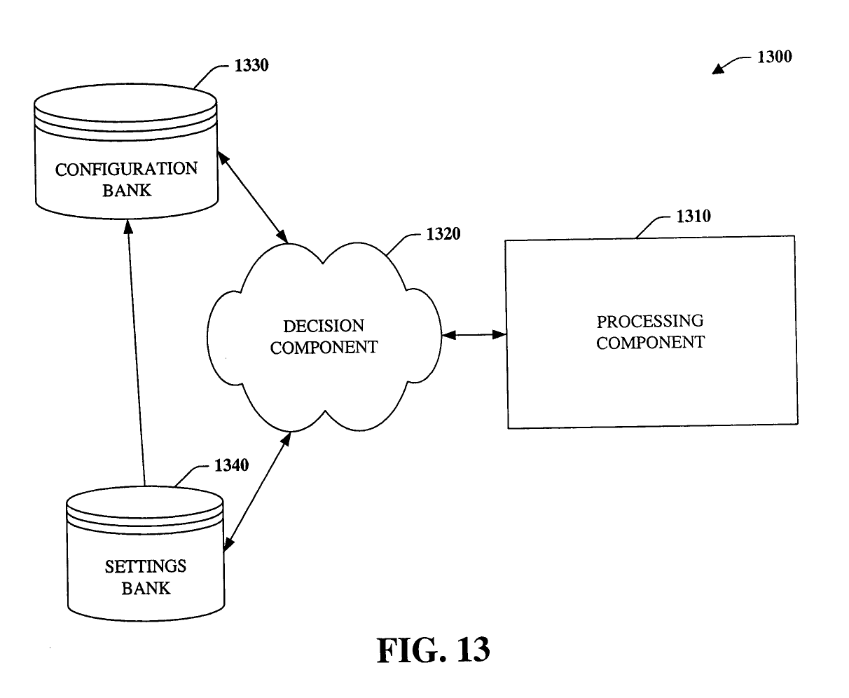

FIG. 13 illustrates a system 1300, in accordance with an aspect of the present invention. The system 1300 can employ various inference schemes and/or techniques that facilitate determining a mode and/or functionality to employ. The system 1300 comprises a processing component 1310, a decision component 1320, a configuration bank 1330 and a settings bank 1340. In general, the processing component 1310 can submit a request for functionality to the decision component 1320, wherein the decision component 1320 can render an inference as to a suitable level of functionality based on the request and convey the suitable functionality to the processing component 1310 after obtaining the pre-packaged functionality from the configuration bank 1330 and/or functionality from the settings bank 1340.

It is to be appreciated that, as used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic, for example, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.) can be employed in connection with performing automatic and/or inferred action in connection with the subject invention.

The processing component 1310 can be utilized in connection with any known device where functionality can be delineated to provide two or more levels of access. For example, the processing component 1310 can be employed in connection with a personal computer, a cell phone, a television, a personal assistant and a security system. A user account associated with the foregoing examples can be established, wherein the functionality at any given time corresponds to the account. In another example, functionality can be selected for any or all accounts.

Typically, the processing component 1310 receives input indicative of the functionality to activate. For example, a user can provide a signal to the processing component 1310, which can be utilized to infer a suitable functionality. In one aspect of the invention, the signal specifies the functionality via a predefined mode. The processing component 1310 provides the signal to the decision component 1320, wherein the decision component 1320 extracts the desired mode. The decision component 1320 then scrutinizes the configuration bank 1330 to locate the mode. After retrieving the mode, the decision component 1320 can return the mode to the processing component 1310.

It is to be appreciated that in addition, the decision component 1330 can utilize information regarding the user, if known, to determine whether the decision component 1320 believes that the requested mode is the mode the user intends to employ. The decision component can employ such a decision to prompt the user for further information, override the user selection and/or store the information as part of a training set. Moreover, if the mode does not exist or is corrupt, the decision component 1320 can attempt to construct or reconstruct the mode via the settings bank 1340, which includes available functionality.

In another aspect of the present invention, the user provides an identification to the processing component 1310. The processing component conveys the identification to the decision component, wherein the decision component maps the user to a mode, retrieves the mode, and forwards the mode to the processing component 1310.

In yet another of the present invention, the identification is utilized in connection with historical and/or predefined data by the decision component 1320 to infer a suitable functionality for the user. The decision component 1320 can provide a predefined mode if at least one of the predefined modes include the inferred functionality, provide a “best” predefined mode that is most likely to meet the petitioners desires, or obtain the functionality from the settings bank 1340. If the functionality is obtained from the settings bank 1340, the decision component can generate a new mode with the functionality and associate the newly generated mode with the user to facilitate inferring suitable functionality the nest time the user provides a request.

The decision component 1320 can additionally update the processing component 1310. For example, the mode that the user is employing can change while being employed. If the user desires, the user can manually refresh the mode or have the mode automatically refreshed. In addition, the decision component 1320 can determine that the users last action implies that a different mode can “better” service the users current desires. For example, a first mode can be employed while the user is making and receiving calls from a cell phone. When the user activates a game, the mode can be refreshed so that incoming calls do not interrupt the user's game. In addition, after a lapse of time, the decision component 1320 can change to a mode that locks all actions except the entering of a unlock code.

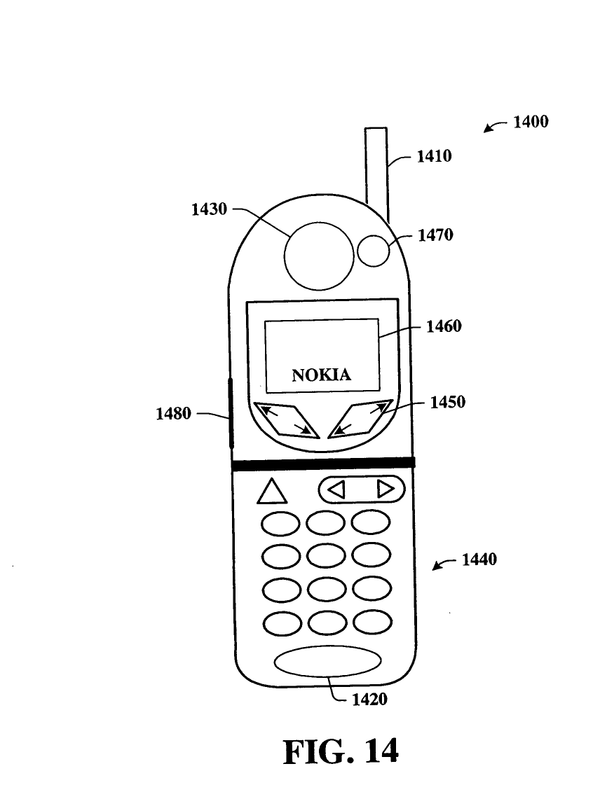

FIG. 14 illustrates an exemplary mobile (e.g., portable and wireless) telephone 1400 that can employ the novel aspects of the present invention. The mobile telephone 1400 comprises an antenna 1410 that communicates (e.g., transmit and receive) radio frequency signals with one or more base stations. The antenna 1410 can be coupled to duplexer circuitry (e.g., as described herein) within the mobile telephone 1400. In addition, the mobile telephone 1400 can include a separate signal-receiving component (not shown) that can also be coupled to the duplexer.

The mobile telephone 1400 further comprises a microphone 1420 that receives audio signals and conveys the signals to at least one on-board processor for audio signal processing, and an audio speaker 1430 for outputting audio signals to a user, including processed voice signals of a caller and recipient music, alarms, and notification tones or beeps. Additionally, the mobile telephone 1400 can include a power source such as a rechargeable battery (e.g., Alkaline, NiCAD, NiMH and Li-ion), which can provide power to substantially all onboard systems when the user is mobile.

The mobile telephone 1400 can further include a plurality of multi-function buttons including a keypad 1440, menu navigating buttons 1450 and on-screen touch sensitive locations (not shown) to allow a user to provide information for dialing numbers, selecting options, navigating the Internet, enabling/disabling power, and navigating a software menue system including features in accordance with telephone configurations. A display 1460 can be provided for displaying information to the user such as a dialed telephone number, caller telephone number (e.g., caller ID), notification information, web pages, electronic mail, and files such as documents, spreadsheets and videos. The display 1460 can be a color or monochrome display (e.g., liquid crystal, CRT, LCD, LED and/or flat panel), and employed concurrently with audio information such as beeps, notifications and voice. Where the mobile telephone 1400 is suitable for Internet communications, web page and electronic mail (e-mail) information can also be presented separately or in combination with the audio signals.

The menu navigating buttons 1450 can further enable the user to interact with the display information. In support of such capabilities, the keypad 1440 can provide keys that facilitate alphanumeric input, and are multifunctional such that the user can respond by inputting alphanumeric and special characters via the keypad 1440 in accordance with e-mail or other forms of messaging communications. The keypad keys also allow the user to control at least other telephone features such as audio volume and display brightness.

An interface can be utilized for uploading and downloading information to memory, for example, the reacquisition time data to the telephone table memory, and other information of the telephone second memory (e.g., website information and content, caller history information, address book and telephone numbers, and music residing in the second memory). A power button 1470 allows the user to turn the mobile telephone 1400 power on or off.

The mobile telephone 1400 can further include memory for storing information. The memory can include non-volatile memory and volatile memory, and can be permanent and/or removable. The mobile telephone 1400 can further include a high-speed data interface 1480 such as USB (Universal Serial Bus) and IEEE 1394 for communicating data with a computer. Such interfaces can be used for uploading and downloading information, for example website information and content, caller history information, address book and telephone numbers, and music residing in the second memory. In addition, the mobile telephone 900 can communicate with various input/output (I/O) devices such as a keyboard, a keypad, and a mouse.

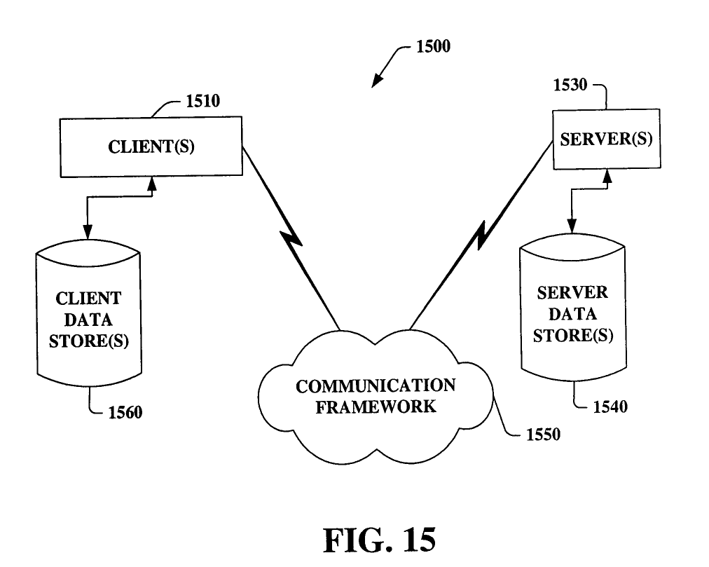

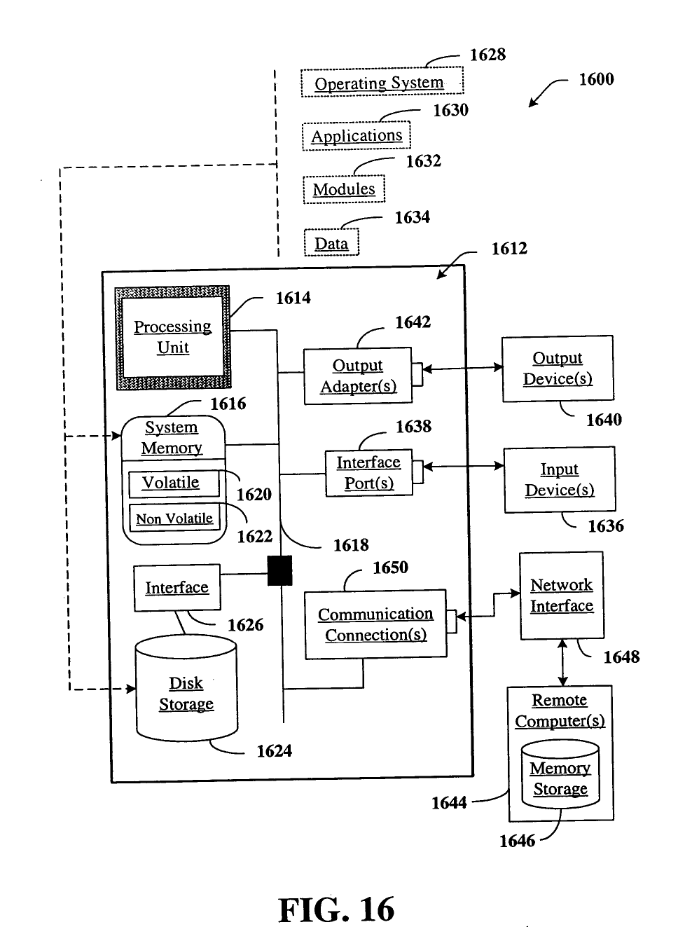

In order to provide a context for the various aspects of the invention, FIGS. 15 and 16 as well as the following discussion are intended to provide a brief, general description of a suitable computing environment in which the various aspects of the present invention can be implemented. While the invention has been described above in the general context of computer-executable instructions of a computer program that runs on a computer and/or computers, those skilled in the art will recognize that the invention also can be implemented in combination with other program modules. Generally, program modules include routines, programs, components, data structures, etc. that perform particular tasks and/or implement particular abstract data types.

Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

FIG. 15 illustrates an exemplary computing environment 1500 in which the present invention can be employed. The system 1500 includes one or more client(s) 1510. The client(s) 1510 can be hardware and/or software (e.g., threads, processes, computing devices). The system 1500 additionally includes one or more server(s) 1530. Likewise, the server(s) 1530 can be hardware and/or software (e.g., threads, processes, computing devices).

One possible communication between a client 1510 and a server 1530 can be in the form of a data packet transmitted between two or more computer processes. The system 1500 further includes a communication framework 1550 that can be employed to facilitate communications between the client(s) 1510 and the server(s) 1530. The client(s) 1510 can interface with one or more client data store(s) 1560, which can be employed to store information local to the client(s) 1510. Similarly, the server(s) 1500 can interface with one or more server data store(s) 1540, which can be employed to store information local to the servers 1530.

With reference to FIG. 16, an exemplary environment 1610 for implementing various aspects of the invention includes a computer 1612. The computer 1612 includes a processing unit 1614, a system memory 1616, and a system bus 1618. The system bus 1618 couples system components including, but not limited to, the system memory 1616 to the processing unit 1614. The processing unit 1614 can be any of various available processors. Dual microprocessors and other multiprocessor architectures also can be employed as the processing unit 1614.

The system bus 1618 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1616 includes volatile memory 1620 and nonvolatile memory 1622. The basic input/output system (BIOS), containing the basic routines to transfer information between elements within the computer 1612, such as during start-up, is stored in nonvolatile memory 1622. By way of illustration, and not limitation, nonvolatile memory 1622 can include read only memory (ROM), programmable ROM (PROM), electrically programmable ROM (EPROM), electrically erasable ROM (EEPROM), or flash memory. Volatile memory 1620 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1612 also includes removable/non-removable, volatile/non-volatile computer storage media. FIG. 16 illustrates, for example a disk storage 1624. Disk storage 1624 includes, but is not limited to, devices like a magnetic disk drive, floppy disk drive, tape drive, Jaz drive, Zip drive, LS-100 drive, flash memory card, or memory stick. In addition, disk storage 1624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1624 to the system bus 1618, a removable or non-removable interface is typically used such as interface 1626.

It is to be appreciated that FIG. 16 describes software that acts as an intermediary between users and the basic computer resources described in suitable operating environment 1610. Such software includes an operating system 1628. Operating system 1628, which can be stored on disk storage 1624, acts to control and allocate resources of the computer system 1612. System applications 1630 take advantage of the management of resources by operating system 1628 through program modules 1632 and program data 1634 stored either in system memory 1616 or on disk storage 1624. It is to be appreciated that the present invention can be implemented with various operating systems or combinations of operating systems.

A user enters commands or information into the computer 1612 through input device(s) 1636. Input devices 1636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1614 through the system bus 1618 via interface port(s) 1638. Interface port(s) 1638 include, for example, a serial port, a parallel port, a game port, and a universal serial bus (USB). Output device(s) 1640 use some of the same type of ports as input device(s) 1636. Thus, for example, a USB port may be used to provide input to computer 1612, and to output information from computer 1612 to an output device 1640. Output adapter 1642 is provided to illustrate that there are some output devices 1640 like monitors, speakers, and printers, among other output devices 1640, which require special adapters. The output adapters 1642 include, by way of illustration and not limitation, video and sound cards that provide a means of connection between the output device 1640 and the system bus 1618. It should be noted that other devices and/or systems of devices provide both input and output capabilities such as remote computer(s) 1644.

Computer 1612 can operate in a networked environment using logical connections to one or more remote computers, such as remote computer(s) 1644. The remote computer(s) 1644 can be a personal computer, a server, a router, a network PC, a workstation, a microprocessor based appliance, a peer device or other common network node and the like, and typically includes many or all of the elements described relative to computer 1612. For purposes of brevity, only a memory storage device 1646 is illustrated with remote computer(s) 1644. Remote computer(s) 1644 is logically connected to computer 1612 through a network interface 1648 and then physically connected via communication connection 1650. Network interface 1648 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1650 refers to the hardware/software employed to connect the network interface 1648 to the bus 1618. While communication connection 1650 is shown for illustrative clarity inside computer 1612, it can also be external to computer 1612. The hardware/software necessary for connection to the network interface 1648 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications, and variations that fall within the spirit and scope of the appended claims.

1. A system that provides an access mode, comprising:
an input component that receives a signal;
a retrieving component that utilizes the signal to obtain the access mode, and
a loading component that activates the access mode to provide a user with functionality associated with the access mode.

2. The system of claim 1, the signal is a user-generated request for the access mode.

3. The system of claim 1, the signal is indicative of the access mode.

4. The system of claim 1, the access mode is one of a plurality of pre-defined access modes.

5. The system of claim 1, the access mode comprises at least one of an infant mode, a toddler mode, a child mode, a teen mode, a friend mode, an owner mode, a security mode and an administrator mode.

6. The system of claim 1, the access mode includes a subset of available functionalities.

7. The system of claim 1, the access mode is configured to disable radio frequency transmission and reception.

8. The system of claim 1, further comprising a component that issues and reads a security code that provides the user with the ability to manually activate and deactivate a particular access mode of a plurality of access modes.

9. The system of claim 1 is employed in connection with at least one of a mobile communication device and a computer.

10. The system of claim 9, the mobile communication device is a cell phone.

11. A system that distributes one or more user-based privileges, comprising:
an identification component that maps a user input to a user;
a filter component that retrieves the one or more privileges associated with the user, the one or more privileges determine a subset of feature(s) from a set of available features that a user can employ; and
a loading component that loads the one or more privileges to a computing device so that the user can employ the subset of features via the device.

12. The system of claim 11, the one or more privileges are associated with at least one level of functionality.

13. The system of claim 11, the one or more privileges are associated with one or more users.

14. The system of claim 11, the one or more privileges are grouped by the user to form a custom level of functionality.

15. The system of claim 11 is employed in connection with one of a mobile communication device and a computer.

16. A system that intelligently selects a mode, comprising:
a component that accepts information;
a decision component that utilizes the information to select the mode, and
a processing component that loads the mode to define a scope of access for a device.

17. The system of claim 16, the mode is one of a pre-defined mode or an automatically generated mode.

18. The system of claim 16, the mode expires after a time duration, a number of user requests, completion of a demonstration or completion of a training application.

19. The system of claim 16, the decision component employs at least one of a statistic, a probability, an inference and a classifier to facilitate selecting the mode.

20. The system of claim 16, the decision component employs one or more of a Bayesian learning model, a Bayesian classifier, a decision tree learning model, a support vector machines, a linear regression, a non-linear regression and a neural network to facilitate selecting the mode.

21. The system of claim 16, the information is associated with one of a signal indicative of the mode or the user.

22. The system of claim 16 is employed in connection with a mobile phone.

23. A methodology that activates a mode, comprising:
receiving a signal indicative of the mode to activate;
interpreting the signal;
retrieving the mode, based at least in part on the interpretation, and
activating the mode.

24. The methodology of claim 23, the mode includes a set or a subset of an available functionality.

25. The methodology of claim 23, the mode is one of a plurality of modes, respective modes have at least one different privilege.

26. The methodology of claim 23, the mode comprises one or more of an infant mode, a toddler mode, a child mode, a teen mode, a friend mode, an owner mode, a security mode and an administrator mode.

27. The methodology of claim 23, the mode is configured to disable radio frequency transmission and reception.

28. The methodology of claim 23 is employed in connection with a mobile phone.

29. A methodology that activates a mode, comprising:
obtaining user information;
mapping the user information to determine a user identification;
utilizing the user identification to select and obtain a level of access associated with the user from a plurality of levels, and
loading the level of access.

30. The methodology of claim 29, the user information comprising indicia indicative of the user.

31. The methodology of claim 29, the user input comprising at least one of a unique identification, a logon, a password, voice, an iris map, a fingerprint and a facial characteristic.

32. The methodology of claim 29, further comprising employing intelligence to facilitate selecting the level of access.

33. A mode dispensing system, comprising:
means for receiving an input associated with a mode;
means for retrieving the mode based at least in part on the received input, and
means for activating the mode.
